(19) United States
(12) Patent Application Publication
(10) Pub. No.: US 2013/0248429 A1
(43) Pub. Date: Sep. 26, 2013

(54) DEVICE FOR PURIFYING WATER

(71) Applicant: Rahul Kashinathrao DAHULE, Nijmegen (NL)

(72) Inventor: Rahul Kashinathrao DAHULE, Nijmegen (NL)

(21) Appl. No.: 13/792,695

(22) Filed: Mar. 11, 2013

Related U.S. Application Data
(63) Continuation of application No. PCT/EP2010/064239, filed on Sep. 27, 2010.
Application No. PCT/EP2010/064239 is a continuation of application No. PCT/EP2011/050609, filed on Jan. 18, 2011.

(51) Int. Cl. C02F 1/32

(52) U.S. Cl. CPC C02F 1/325
USPC 210/150; 210/251; 210/205

(57) ABSTRACT

A device for purifying water includes: a reactor housing having an inlet opening for supplying polluted water and an outlet opening for draining the purified water from the reactor housing; hydrodynamic cavitation means arranged in the reactor housing for causing cavitation in the polluted water; main light means for irradiating the polluted water with ultraviolet light, wherein the main light means provide a polychromatic and/or monochromatic pulsed ultraviolet light, which is synchronized selectively with the specific cavitation event(s) in the polluted water.

### CROSS REFERENCE TO RELATED APPLICATIONS

This is a U.S. continuation application claiming priority from PCT/EP2010/064239 tiled Sep. 27. 2010 and PCT/EP2011/050609 filed Jan. 18, 2011, each of which are incorporated herein by reference.

The invention relates to a device for purifying water comprising:
a reactor housing having an inlet opening for supplying polluted water and an outlet opening for draining the purified water from the reactor housing;
hydrodynamic cavitation means arranged in the reactor housing for causing hydrodynamic cavitation in the polluted water;

main light means for irradiating the polluted water with ultraviolet light.

Such a device is known from a number of publications.

U.S. Pat. No. 4,990,260 describes a device for purifying water comprising two separate steps. In the first step, the polluted water is transported through a venturi, arranged in a reactor chamber, such that cavitation is caused. In the second step the oxidizable contaminants are oxidized by UV light in a separate reactor chamber.

This invention exploits hydrodynamic cavitation, which is the result of a substantial pressure reduction in the liquid at a constant temperature. If the pressure is reduced and maintained long enough below a certain critical pressure, determined by the physical properties and conditions of the liquid, cavitation will result.

As a result of cavitation, vacuum, vapor and gas bubbles are created in the liquid. These bubbles cause the formation of voids. Millions of cavities grow and collapse simultaneously at different locations. When these bubbles implode tiny pockets of high temperatures and pressures are created.

The shockwave caused by the :implosion of the bubbles will disrupt or weaken microbes in the polluted water. In certain cases the implosion of a bubble generates a micro-jet, which depends on the intensity of cavitation and can break the cell wall of nearby microbes or even completely destroy the cells of microbes, Cell disruption takes place by a combination of several actions of cavitation such as high velocity liquid jets and shock waves.

Another aspect of cavitation is the decomposition of water. During the collapse phase of the bubble, liquid vapour tends to condense at the bubble wall. But during extremely rapid transient bubble collapse, the vapour at the centre of the bubble has insufficient time to escape and this excess vapour is trapped in the bubble at the time of minimum radius reached during the collapse when the temperatures and pressures inside the bubble is at the extreme. At these conditions the vapour inside the bubble can decompose to yield OH radicals which get mixed with the bulk liquid when the bubble bursts during the transient collapse and induce various chemical reactions. This chemical effect of cavitation is known as the sonochemical effect.

Thus due to the high pressure and high temperature, the water molecules decompose into reactive hydrogen atoms and hydroxyl radicals, which can degrade the chemical pollutants

The short lived radicals are capable of oxidation and reduction in the immediate vicinity of the bubble. With cavitation, Hydroxyl (OH.) and Hydrogen (H.) radicals are formed. These radicals initiate chemical reactions and lead to degradation of organic pollutants. Hydrogen peroxide, a strong oxidizing agent, can be formed by the reaction between two hydroxyl radicals.

Depending on the intensity of cavitation produced, ultraviolet (UV) light is used to further inactivate microorganisms, which are riot or only slightly affected by the cavitation process.

UV light is the electromagnetic radiation in the range of 100-400 nanometers (nm). From this range, the range of 200-280 nm is particularly important as light within this range is absorbed by DNA (or RNA in some viruses), causing the destruction of the DNA and accordingly of the microbe.

UV light causes the damage of the DNA and can also trigger a photochemical reaction affecting other bio-molecules like proteins and repair enzymes. Biochemical reactions induced by UV such as Protein absorption in the wavelengths ranging from 240 to 280 nanometers (nm) effectively inactivates microorganisms by irreparably damaging their nucleic acid. The most potent wavelength for damaging DNA is approximately 265 nm. Certain wavelengths of UV light also produce free radicals providing oxidation.

UV rays can also be used to trigger advanced oxidation, producing hydroxyl radicals in various modes such as vacuum U V photolysis (wavelengths lesser than 190 nm), titanium dioxide catalytic UV, hydrogen peroxide assisted UV (wavelengths lesser than 300 nm) etc.

Mold/fungi, bacteria and viruses are the three basic types of biological contaminants, and are all susceptible to UV energy. The dose of UV needed to affect each group varies. Generally, viruses are the easiest to sterilize, followed by bacteria. Mold and fungi are the hardest to eliminate and require very long exposure times.

It should be noted that the invention is related to hydrodynamic cavitation and not to acoustic cavitation.

Acoustic Cavitation (AC) is a pressure variation in liquid due to an ultrasonic wave. The nature of bulk pressure variation in AC is sinusoidal around the mean or ambient pressure. Ultrasound passes through the medium in the form of compression/rarefaction cycles. The bubbles expand in the rarefaction half cycle and subsequently compress or even collapse in the compression half cycle, given the condition that the amplitude of the ultrasonic wave is sufficiently high.

When a liquid is irradiated with ultrasound, the ultrasound waves pass through the medium in a series of alternate compression and expansion cycles. When the acoustic amplitude is large enough to stretch the molecules during its negative pressure (rarefaction) cycle to a distance that is greater than the critical molecular distance to hold the liquid intact, microbubbles are created that then collapse in the subsequent compression cycle, giving rise to extremes of temperature and pressure. Estimates have suggested that temperatures greater than 5,000° C. and pressures greater than 1000 atm can be produced locally during the collapse of these vapor bubbles.

In AC lower frequencies promote more violent shock waves and higher frequencies favour the diffusion of OH radicals to the liquid phase.

Hydrodynamic Cavitation (HC) on the other hand is a pressure variation in a flow of liquid due to pressure variation in velocity of flow which is a result of change in geometry. The pressure variation in HC is substantially linear. HC is generated by pressure reduction, which is present throughout the main/bulk part of the liquid, while AC only affects a small part of the liquid. It is known from the published literature that in HC owing to longer life of the bubble and the higher velocity from which they are swept away from the point of generation, the actual volume of the bulk liquid exposed to cavitation is higher for HC than that in AC. Furthermore, bubble/cavity collapsing behavior in the case of HC is accompanied by a large number of pressure pulses of relatively smaller magnitude, compared with just one or two pulses under AC. Thus the radial motion of a bubble due to time variation of bulk pressure in the liquid medium and overall bubble dynamics are different in AC and HC.

in US 2010090124 it is proposed to combine an impeller induced cavitation and UV irradiation in a single reactor chamber. A rotary cavitator is arranged in the reactor chamber to cause caviation in the fluid. The cavitation zone is furthermore irradiated by static UV light, to aid in the further destruction of the pollutants. It is known that the energy consumption in such types of rotating cavitators is much higher and flexibility of the design parameters is low compared to cavitation reactors based on the use of orifice plates or venturis.

A problem with the known devices is photo-reactivation and dark repair by UV irradiated microbes. Under certain conditions, some organisms are capable of repairing damaged DNA and reverting back to an active state in which reproduction is again possible. Typically, photo-reactivation occurs as a consequence of the catalyzing extent of sunlight at visible wavelengths outside of the effective disinfecting range. The extent of reactivation varies among organisms. As this publication is not focused on killing the organisms, some of these organisms are capable of repairing themselves despite the combined effect of cavitation and UV light.

The ability to reactivate varies significantly depending on
the type of UV damage inflicted and
by the level of biological organization of the microorganism. In photo-reactivation the repair is carried out by an enzyme called photolyase which reverses the UV-induced damage.

In case of dark repair, the reversal of the destructive forces is carried out by a complex combination of more than a dozen enzymes. To start reactivation (both light and dark), these enzymes must first be activated by an energy source. For photo reactivation this energy is supplied by visible light (300-700 nm), while for dark-repair the energy is provided by nutrients within the cell. In both cases, reactivation is achieved by the enzymes repairing the damaged DNA, allowing replication to take place again. Although a significantly high dosage of UV irradiation than required is often considered with medium pressure UV lamps to circumvent the problems of reactivation of DNA, it cannot however truly prevent/eliminate reactivation problems due to complicated yet realistic biological aspects of the microorganisms such as thick/rigid structures of the cell wall and/or cyst/sac/shell type of external structure and/or microbes trapped within microbes and/or presence of host cells in the microbes, and/or nutrient status of the microbes etcetera.

U.S. Pat. No. 6,555,011 uses acoustic cavitation along with polarity of energies such as a monochromatic pulsed laser, a microwaves, a Tio2 (photocatalyst) coated surface to concentrate diversified electromagnetic and acoustic energies in a compounded concentrator geometry.

The acoustic energy is used to cause acoustic cavitation, which could be time synchronized with UV-light.

The major shortcoming of the acoustic-cavitation- based reactor according to the prior art lies in its directional sensitivity: the cavities formed do not travel very far from the point of inception as they collapse within a very short period after inception

Therefore the cavitation effect (i.e., the high temperature and pressure pulses produced because of the bubble collapse) pertains to a very small area near the transducer. Thus, acoustic cavitation is not in the bulk of the liquid and does not affect the main portion of the liquid. Furthermore acoustic cavitation device create much more excess sound energy/pressure amplitude than that is required for cavitation to occur. Most of the energy delivered by the transducer in acoustic cavitation goes wasted in attenuation of sound waves, lower energy efficiency of transducers, and viscous heating.

It is now an object of the invention to provide a device for purifying water at an optimal energy input, which reduces or resolves the above mentioned disadvantages of the prior art. Addressing this problem has interesting commercial applications such as ships ballast water treatment with killing mechanism.

This object is achieved with a device according to the preamble, which is characterized in that the main light means provide a pulsed ultraviolet light, which is synchronized with the hydrodynamic cavitation mechanism in the polluted water.

The intense pressure gradient, resulting from the cavitation, improves the penetration of UV light through the microbial cell membrane. Also, cavitation can facilitate the disagglomeration of micro-organism clusters in solution, such that the UV light can more easily reach the individual micro-organisms.

Thus by synchronizing the pulsed ultraviolet light with the selective hydrodynamic cavitation events a synergistic effect on the killing mechanism of microbes at an optimal energy input is obtained, which is not present in the prior art, Moreover with this invention high turbid water can be processed for purification since pulsed UV rays are higher in power and longer in transmission length than the conventional continuous UV lamps and also pulsed UV rays have relatively deeper penetration on the microbes. It is anticipated that turbid water may enhance the additional nucleation sites for the extra cavitation events thereby increasing the cavitation intensity. In this context the combined action of hydrodynamic cavitation and pulsed UV can be much more synergistic on the killing mechanism even in the turbid water.

It is known that cavitation occurs at a length scale (ranging from few micrometers to few nanometers) which is typically also the size of the microbial cell. The cavitation increases the pressure and provides disagglomeration, which increases the effectiveness of the ultraviolet light on the microbes.

Unlike acoustic cavitation, hydrodynamic cavitation affects larger volumes and is uniform throughout the water processing chamber due to efficient mixing and thus there is no problem of directional sensitivity. Because of large number of pressure pulses of relatively smaller magnitude in MC reactor compared to those in the AC reactor, number of active UV pulse synchronization with specific yet variable hydrodynamic cavitation event(s) are maximized at an optimal energy input which further catalyses the events of killing action on the microbes.

Synchronizing Pulsed UV with selective hydrodynamic cavitation event(s) thus triggers an optimal energy transformation for the microbial disinfection at complementary mechanisms of UV and hydrodynamic cavitation. This combined synchronization optimally delivers energy for the maximized killing efficiency for the microbial disinfection on the length scale of transformation in contrast to conventional methods of disinfection, where most of the energy is wasted in raising the energy level of whole bulk of liquid which otherwise is not required.

In addition to addressing the problem of water treatment, this invention can also be used to address mass transfer intensification to accelerate chemical or mixing processes in liquid-liquid or gas-liquid mediums.

Preferably the bubble collapse event (mode of transient cavitation), within the cavitation, falls at an interval of simmer time of pulsed UV. This way upon release of energy from the bubble collapse, pulsed UV can be easily penetrated into the weakened disrupted microbial structure.

The main light means can comprise additional light means which also provide pulsed UV light and which overlaps with the other pulsed UV light.

For a stable cavitation mode, which is mostly evident in venturi configuration of hydrodynamic cavitation where cavities undergo multiple volumetric oscillations to produce turbulent shear stress, the pulsed UV cycle may be matched with the oscillation frequency of the cavitation bubbles so that there is successive action of a peak power pulse of the UV followed by the imposed, yet increased, stress resulting from the oscillation of the cavity. Furthermore, variable energy dissipation rate in the water resulting from the variable turbulent shear stresses developed with bubble oscillations from the stable cavitation can additionally be synchronized with the pulsed UV.

For combined mode of stable and transient cavitation, pulsed UV synchronization can be selectively performed based on the respective yet different cavitation event(s) along the differential cavity trajectories of stable and transient cavitation modes.

Design parameters of pulse width and pulse frequency can be altered to change the simmer time and can be made dependent on the size of the cavitation bubble and bubble collapsing duration, which typically varies from 10⁻⁸ to 10⁻³ seconds.

In an embodiment of the device according to the invention the main light means are positioned downstream from the cavitation means near the implosion area.

In a preferred embodiment of the device according to the invention the position of the main light means is variable. By having a variable positioning of the main light means, the device can be tuned to the composition of the polluted water entering the. device. The composition of the polluted water could influence the cavitation characteristics as a result of which the optimal position of the main light means may have to be varied. Main light means could be smart combination of pulsed polychromatic lamps such as Xenon-bused flash lamps, surface discharge lamps, and/or monochromatic UV LEDs, dielectric barrier discharge lamps.

Another preferred embodiment comprises secondary light means for continuously irradiating the polluted water with ultraviolet light.

Preferably the light means are arranged axially or concentrically relative to the water flow. This ensures that the light means irradiate the cavitation zone evenly.

The light means could comprise an elongate lamp, a ring shaped light and/or a spiral shaped light.

UV LEDs and dielectric barrier discharge (DBD) UV lamps of different monochromatic wavelengths can be used as secondary light means in the vicinity of the bubble collapse to accelerate timely UV penetration towards the microbes. The secondary light means contribute to the effect of the main light means. Reflector materials (such as polished sheet of aluminum, Alzak) along the inside walls of the water processing housing may be considered for the selective surface to further optimize the variable synchronization of main and/or secondary light means with variable hydrodynamic cavitation event(s).

Yet another embodiment of the device according to the invention comprises a sensor for registering the cavitation frequency of oscillating bubbles which may or may not burst, wherein the sensor is coupled to the main light means. By measuring the frequency of the cavitation, the frequency of the main light means can be controlled, such that the light is synchronized with the cavitation. It must be understood that a number of such frequencies can be controlled since each of these frequencies will indirectly represent variable synchronization event(s) of main/secondary light means with variable hydrodynamic cavitation event(s),

In still another embodiment of the device according to the invention, the cavitation means may additionally comprise ultrasound means producing an acoustic wave for causing secondary cavitation, and are coupled to the main light means to synchronize the pulsed light with the cavitation effect. The ultrasound means can be supplemented with other cavitation means. The ultrasound means cause acoustic cavitation, which can contribute to the main hydrodynamic cavitation with intense, rapid and localized collapse of the bubbles. Additionally secondary acoustic cavitation may be considered for inactive and/or selective cavitation zone inside the water chamber. Thus, according to this embodiment the main hydrodynamic cavitation is combined with secondary acoustic cavitation.

It is known in the prior art that by providing an air-inlet in the reactor housing, air will be sucked in at the point in the reactor where near-vacuum conditions are generated, such that gaseous cavitation is triggered. As both vaporous cavities and gaseous cavities are generated, conditions are created that aid in the local formation of hydrogen peroxide. Increased concentration of oxygen by the formation of hydrogen peroxide oxidizes the microbes. An optimal amount of air during cavitation enhances the microbial destruction efficiency significantly.

By adding air through the air-inlet, typically around the cavitation reactor area where the pressure recovery rate downstream of the restriction nozzle is increased where collapse of the bubbles (in the mode of transient cavitation) is accelerated promoting diffusion of OH⁻ radicals to the liquid phase resulting to the formation of H₂O₂ in the same region. Thus, the cavitation reactor-area following a point where air is sucked in is a potential region of local formation of hydrogen peroxide.

Another preferred embodiment of the device according to the invention comprises an air-inlet arranged downstream of the hydrodynamic cavitation means, such that the reactor area where air is sucked into the polluted water, which is a potential region of hydrogen peroxide formation. Preferably this zone is irradiated with continuous or pulsed UV rays of monochromatic wavelength preferably in the range of 210-225 nm. This action maximizes the killing mechanism on the microbes with combined UV and hydrogen peroxide assisted advanced oxidation in the selective area of the reactor.

Preferably a filter or a hydrocyclone connected to the outlet opening of the reactor housing is provided. This filter may be used to remove the debris of microbes.

The cavitation means of a device according to the invention can comprise at least one venturi and/or at least one orifice plate having a plurality of holes.

In case of at least one orifice plate, the light means are preferably arranged adjacent the orifice plate on the cavitation side. The light means are to be arranged outside of the plurality of holes, in such a way that the light means do not block the holes. The light means could be arranged at the outer boundary of the orifice plate, or in between the plurality of holes. Alternatively the light means could also be individually arranged for each of the individual hole on the orifice plate. UV light reflectors and/or peripherals of the light means such as electrodes, vibration-proof assembly, supporting system, wiper system, earthing may be arranged on the orifice plate without blocking the holes.

Preferably, the hydrodynamic cavitation means are concentrically arranged with the water flow. This ensures that the generated hydrodynamic cavitation spreads evenly over the water to be purified.

In yet another embodiment of the device according to the invention, a gas supply is arranged upstream of the hydrodynamic cavitation means to selectively synchronize specific cavitation event(s) associated with gas bubbles and/or bubbles with substantial gas content with pulsed and/or continuous UV.

It is known from a published literature that by introducing cavitation gas bubbles or nuclei externally in the upstream flow prior to venturi configuration, a well-defined and consistent pressure variation is provided in the flow for radial bubble motion. In such a configuration a good control over cavitation intensity is produced due to good control over rate of nucleation and nature of pressure variation driving the bubble motion. Moreover the total cavitation intensity in the reactor is controlled by controlling the amount of gas introduced through the sparger upstream of the constriction. Transient motion of the bubbles can be obtained with the venturi configuration giving rise to OH radical formation, which induce the sonochemical effect.

Pulsed UV synchronization in such gas-fed venturi configuration is done differently on gaseous bubbles. This synchronization is thought to be more energy efficient to provide ease of control and scale-up options.

In yet another embodiment of the HC means with Orifice device according to the invention the gas supply was positioned to as to introduces gas bubbles into a selected number of holes of the orifice plate and triggers cavitation event(s) along the paths of gaseous cavities which get selectively synchronized with variable operating parameters of pulsed UV.

When a gas is introduced unevenly to few selective holes of the multi-hole orifice plate, trajectories of gaseous bubbles will be generated behind the orifice plate. The location cluster where these paths of gaseous bubbles are maximized can be selectively synchronized with variable pulsed UV parameters. In short, air/gaseous bubbles are differently synchronized over vaporous bubbles with pulsed UV to maximize killing action for the microbial disinfection at an optimal energy input.

By using two hydrodynamic cavitation means in series, the efficiency is increased, while with at least two hydrodynamic cavitation means in parallel the flow is increased.

Two hydrodynamic cavitation means with UV light means can also be combined in parallel, wherein the outlet openings of both cavitation means are combined to collide with significant kinetic energy and shear in the center. This could improve the synergetic effect as the water flow in which the cavitation and UV effects occur is combined towards the single outlet opening. The mixing zone from the collision area may additionally be irradiated with extra UV light means to bring out magnified synergy from the dual action of hydrodynamic cavitation and UV. The said extra UV light means for this purpose can preferably be arranged in/around the collision cluster and in the perpendicular direction to the flow for their ease of removal and exchange.

These and other features of the invention will be elucidated in conjunction with the accompanying drawings.

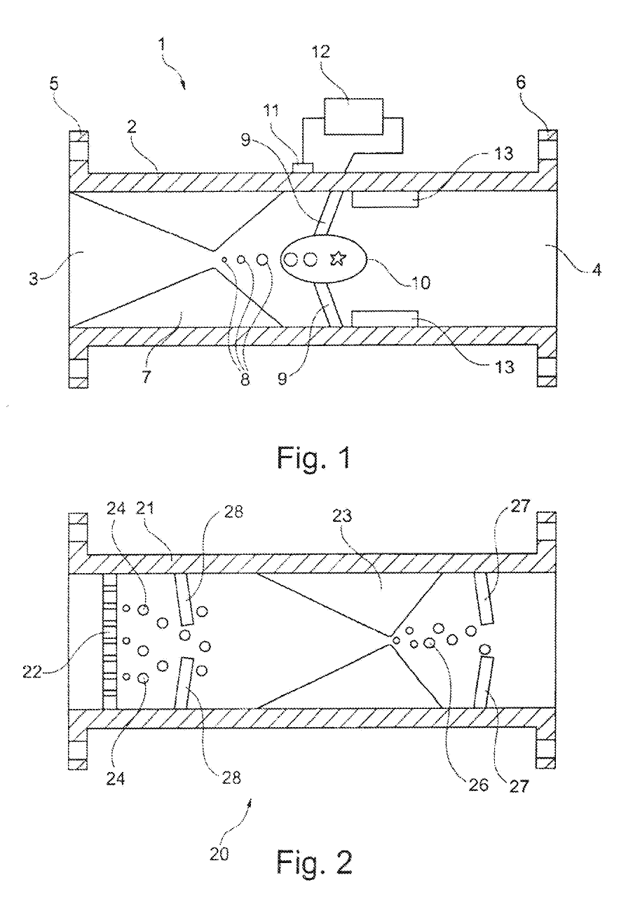

FIG. 1 shows a schematic cross sectional view of a first embodiment of a device according to the invention.

FIG. 2 shows a schematic cross sectional view of a second embodiment of a device according to the invention.

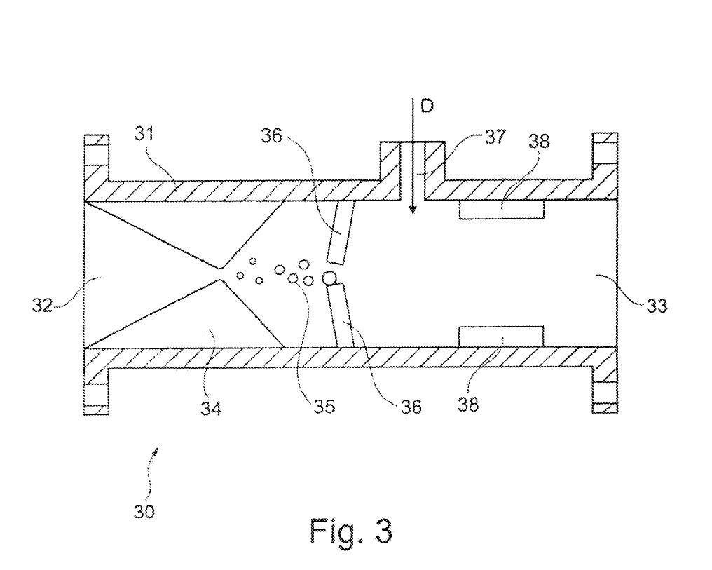

FIG. 3 shows a schematic cross sectional view of a third embodiment of a device according to the invention.

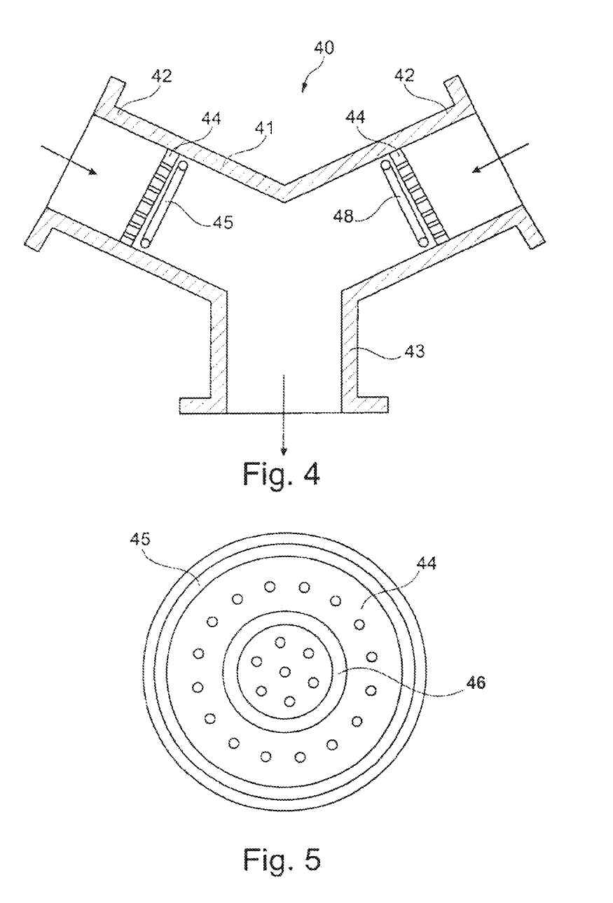

FIG. 4 shows a schematic cross sectional view of a fourth embodiment of a device according to the invention.

FIG. 5 shows a side view of an orifice plate of FIG. 4.

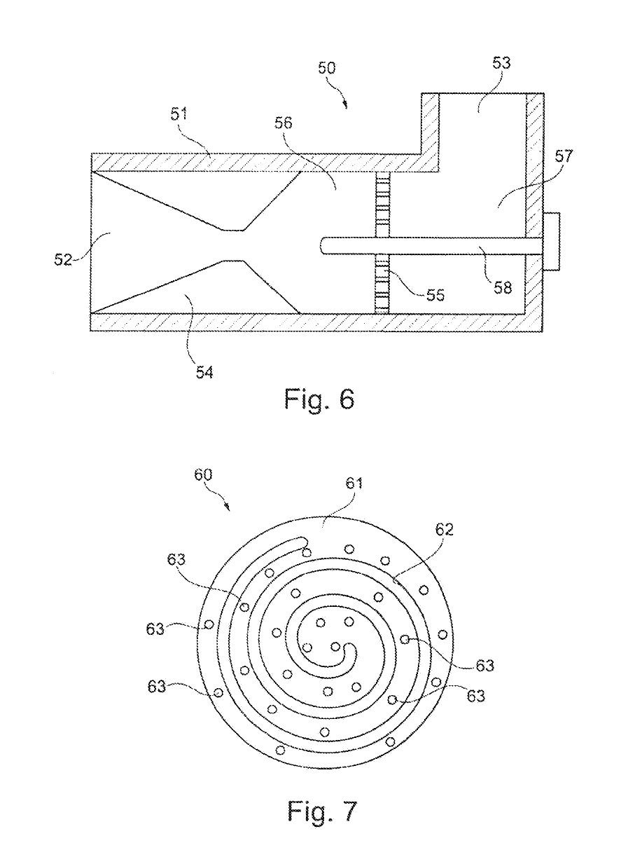

FIG. 6 shows a schematic cross sectional view of a fifth embodiment of a device according to the invention.

FIG. 7 shows a side view of a variant of an orifice plate for the invention.

FIG. 1 shows a first embodiment 1 of a device according to the invention. The device 1 has a reactor housing 2 with an inlet opening 3 and an outlet opening 4. Both the inlet opening 3 and the outlet opening 4 have flanges 5, 6 with which the reactor housing 2 can be mounted into a pipeline.

A venturi 7 is arranged downstream of the inlet opening 3 in the reactor housing 2. When polluted water is fed to the inlet opening 3, the water is subjected to cavitation by the venturi 7, such that cavitation bubbles 8 are created.

Downstream of the venturi 7 main light means 9 are arranged. These main light means 9 can provide polychromatic pulsed ultraviolet light for irradiating the polluted water at the cavitation zone 10.

A sensor 11 is provided for sensing the frequency of the cavitation, such that a controller 12 can control the main light means 9 based on the frequency of the cavitation and thus synchronize the pulsed ultraviolet light with the cavitation.

Further downstream are arranged secondary light means 13 which provide a monochromatic ultraviolet light to assist in the purifying of the water. These secondary light means 13 are used in this embodiment to irradiate the selective reactor area where there is a potential formation of hydrogen peroxide. The monochromatic light from the secondary light means could originate from a DBD lamp and could be pulsed.

FIG. 2 shows a second embodiment 20 of a device according to the invention. Within a reactor housing 21 an orifice plate 22 and a venturi 23 are arranged in series.

The orifice plate 22 is provided with a plurality of holes, such that cavitation zone 24 is generated downstream of the plate 22. This cavitation zone 24 is irradiated with polychromatic pulsed ultraviolet light 25 with the same or a different polychromatic spectrum to destroy the microbes within the water.

In the second stage, at the venturi 23 the polluted water is subjected to cavitation again, resulting in a second caviation zone 26. This second cavitation zone 26 is again irradiated by polychromatic pulsed ultraviolet light 27 to further destroy the microbes within the water.

FIG. 3 shows a third embodiment 30 according to the invention. This third embodiment 30 has a reactor housing 31 with an inlet opening 32 and an outlet opening 33.

A venturi 34 is arranged in the housing 31 causing a cavitation zone 35 in the polluted water, which is fed to the inlet opening 32. This cavitation zone 35 is irradiated by polychromatic pulsed ultraviolet light from main light means 36.

Just downstream of the main light means 36 an air inlet 37 is arranged through which ambient air A is sucked into the polluted water as a result of the low pressure. Secondary light means 38 are provided to have the water continuously irradiated with preferably monochromatic ultraviolet light, to trigger advanced oxidation with UV and locally formed hydrogen peroxide in the selective area within the reactor.

By using such combined cavitation and UV means housed in a single reactor arranged in series, the disinfection and advanced oxidation efficiency is increased, while such single reactors when arranged in parallel units the flow capacity can be increased. The type of the embodiment in serial or parallel arrangements may be varied to optimize the maximum killing action on the challenge microbe(s) in the polluted water.

FIG. 4 shows a cross sectional view of an embodiment 40 according to the invention. The embodiment 40 comprises a reactor housing 41 with two separate inlets 42 and one outlet 43.

Inside each inlet part 42 an orifice plate 44 is arranged to provide hydrodynamic cavitation in the water flow entering the inlet 42.

After the cavitation is induced in two orifice plates 44 through two different inlets, the water flows are combined at the center of the reactor housing, Which could improve the effect of the cavitation.

Ring shaped UV lights 45, 46 are arranged downstream of each orifice plate 44 (see also FIG. 5). These UV lights 45, 46 are concentrically arranged and promote the elimination of bacteria and the like. UV light means 45, 46 may be optimized to choose one of them to operate in pulsed mode whilst the second one to he operated in continuous mode.

FIG. 6 Shows a cross sectional view of a fifth embodiment 50 of the invention. This embodiment 50 has a reactor housing 51 with an inlet 52 and an outlet 53.

Inside the reactor housing a venturi 54 is arranged and downstream of this venturi 54 is arranged an orifice plate 55. This venturi 54 and orifice plate 55 will create two cavitation zones 56, 57, eliminating bacteria and the like.

An elongate UV-light 58 is axially arranged in the reactor housing 51 and extends in both the two cavitation zones 56, 57. This embodiment has the advantage, that the elongate UV-light 58 can easily be exchanged when the light 56 fails.

FIG. 7 shows a side view of an embodiment 60 of an orifice plate 61 with a spirally shaped UV light 62 placed in front of the orifice plate 61.

The holes 63 are preferably also arranged in a spiral shape, such that the spiral UV light 62 can easily be placed in between the holes 63. The advantage of this embodiment is that the UV light 62 is arranged near each hole 63 of the orifice plate 61, while the UV light 62 is still one single part and thus can easily be exchanged.

1. Device for purifying water comprising:
a reactor housing having an inlet opening for supplying polluted water and an outlet opening for draining the purified water from the reactor housing;
hydrodynamic cavitation means arranged in the reactor housing for causing cavitation in the polluted water;
main light means for irradiating the polluted water with ultraviolet light characterized in that
the main light means provide a pulsed ultraviolet light, which is variably synchronized with the hydrodynamic cavitation events in the polluted water.

2. Device according to claim 1, wherein the main light means are positioned downstream from the cavitation means near the implosion area, in case of transient cavitation mode, or near the oscillating bubbles contributing to variable shear stress, in case of stable cavitation mode.

3. Device according to claim 1, wherein the position of the main light means is variable.

4. Device according to claim 1, comprising secondary light means for irradiating the polluted water with ultraviolet light in continuous or pulsed mode with monochromatic or polychromatic wavelengths.

5. Device according to claim 1, comprising a sensor for registering the cavitation frequency, wherein the sensor is coupled to the main light means.

6. Device according to claim 1, wherein the cavitation means comprises acoustic means producing an ultrasound wave for causing a secondary cavitation, which are coupled to the main light means to synchronize the pulsed light with the acoustic cavitation.

7. Device according to claim I, comprising an air-inlet arranged downstream of the cavitation means, such that air is sucked into the polluted water.

8. Device according to claim 1, comprising a filter or a hydrocyclone connected to the outlet opening of the reactor housing.

9. Device according to claim 1, wherein the hydrodynamic cavitation means comprises at least one venturi and/or at least one orifice plate having a plurality of holes.

10. Device according to claim 1, wherein the hydrodynamic cavitation means comprises at least one venturi and/or at least one orifice plate having a plurality of holes wherein the hydrodynamic cavitation means are concentrically arranged with the water flow.

11. Device according to claim 1, wherein upstream of the hydrodynamic cavitation means a gas supply is arranged.

12. Device according to claim I , wherein the hydrodynamic cavitation means comprises at least one venturi and/or at least one orifice plate having a plurality of holes and wherein upstream of the hydrodynamic cavitation means a gas supply is arranged, wherein the gas supply introduces gas bubbles into a selected number of holes of the orifice plate.

13. Device according to claim 1, comprising secondary light means for irradiating the polluted water with ultraviolet light in continuous or pulsed mode with monochromatic or polychromatic wavelengths, where the lamps irradiating UV light are at least partially submerged inside the water medium.
